(19) United States
(12) Patent Application Publication
(10) Pub. No.: US 2022/0006365 A1
(43) Pub. Date: Jan. 6, 2022

(54) BOBBIN, STATOR AND THERMISTOR POSITIONING METHOD

(71) Applicant: Johnson Electric International AG, Murten (CH)

(72) Inventors: Caiyong ZHANG, Shen Zhen (CN); Jinqiang JU, Shen Zhen (CN); Karwai LAM, Hong Kong (CN); Wai YEN, Hong Kong (CN)

(21) Appl. No.: 17/367,796

(22) Filed: Jul. 6, 2021

(30) Foreign Application Priority Data
Jul. 6, 2020 (CN) 202010641675.X

(51) Int. Cl. H02K 11/25; H02K 3/52; H02K 3/28

(52) U.S. Cl. CPC H02K 11/25; H02K 2203/12; H02K 3/28; H02K 3/522

(57) ABSTRACT

A stator, a bobbin and a method for positioning a thermistor are provided. The bobbin can be fixed on a stator core of the stator and includes a ring shaped stop plate and a plurality of winding portions extending downward from a sidewall of the stop plate. A positioning groove is defined in the sidewall of the stop plate toward one of the winding portions for accommodating the thermistor, the positioning groove opens toward the one of the winding portions.

### CROSS REFERENCE TO RELATED APPLICATIONS

This non-provisional patent application claims priority under 35 U.S.C. § 119(a) from Patent Application No. 202010641675.X filed in The People's Republic of China on Jul. 6, 2020.

### FIELD OF THE INVENTION

The present invention relates to the field of electric technology, in particular to a bobbin, a stator and a positioning method of a thermistor.

### BACKGROUND OF THE INVENTION

Windings of a stator generate heat when a motor is running, especially when a load carried by the motor is too large, the temperature of the windings will rise significantly, so the temperature of the windings needs to be monitored. A thermistor is usually used to detect the temperature of the windings. The thermistor is usually fixed by gluing the thermistor on the windings or welding the thermistor on a circuit board. However, the way of gluing the thermistor on the windings inevitably leads to the unstable positioning of the thermistor and the complexity of the process, while the way of soldering the thermistor on the circuit board results in low detection accuracy due to the long distance from the windings.

### SUMMARY OF THE INVENTION

In view of this, the present invention aims to provide a bobbin, a stator having the bobbin, and a thermistor positioning method that can solve the above-mentioned problems.

The present disclosure provides a bobbin for a stator, the bobbin includes a ring shaped stop plate and a plurality of winding portions extending downward from a sidewall of the stop plate, a positioning groove is defined in the sidewall of the stop plate toward one of the winding portions for accommodating a thermistor, the positioning groove opens toward the one of the winding portions.

Preferably, a radial inner end of each winding portions is provided with a wire stopper extending upward, the positioning groove is arranged above the one of the winding portions and is opposite to the wire stopper on the one of the winding portions in a radial direction of the bobbin.

Preferably, the positioning groove comprises a bottom wall and two side walls extending in an axial direction of the bobbin, and defines an upward first opening in the axial direction of the bobbin and a second opening in a radial direction of the bobbin facing the corresponding wire stopper.

Preferably, the two side walls are configured as two inclined surfaces or arc surfaces that expand and extend outward from the bottom wall.

Preferably, two opposite recesses are defined in the two side walls for holding the thermistor in the positioning groove.

The present disclosure also provides a stator, the stator includes a stator core; a bobbin mounted on the stator core, the bobbin comprising two stop plates respectively fixed to two axial ends of the stator core, and a plurality of winding portions extending from a sidewall of each stop plate toward the opposite stop plate; a plurality of stator windings wound around the plurality of winding portions; and a thermistor, a positioning groove is defined in the sidewall of one of the stop plates toward one of the winding portions on the one of the stop plates for accommodating the thermistor, the positioning groove opens toward the stator winding on the one of the winding portions.

Preferably, the positioning groove comprises a bottom wall and two side walls extending in an axial direction of the bobbin, and defines a first opening in the axial direction of the bobbin, the thermistor is received in the positioning groove with a top of the thermistor protruding out of the first opening and electrically connected to a circuit board.

Preferably, the circuit board is fixed on the one of the stop plates having the thermistor, the thermistor comprises two pins on the top, the pins protrude out of the first opening and fix the thermistor to the circuit board.

Preferably, the positioning groove defines a second opening between the two side walls toward the stator winding on the one of the winding portions, a side of the thermistor is an arc shape and exposed from the second opening to be adjacent to or abut against the stator winding on the one of the winding portions.

Preferably, the two side walls are configured as two inclined surfaces or arc surfaces that expand and extend outward from the bottom wall.

Preferably, two opposite recesses are defined in the two side walls for holding the thermistor in the positioning groove.

The present disclosure also provides a positioning method for a thermistor, the method includes: Step 1: providing a stator having a stator core and a bobbin mounted on the stator core, wherein the bobbin comprises two stop plates respectively fixed to two axial ends of the stator core, and a plurality of winding portions extending from a sidewall of each stop plate toward the opposite stop plate, a positioning groove is defined in the sidewall of one of the stop plates toward one of the winding portions on the one of the stop plates, the positioning groove opens toward the one of the winding portions; and Step 2: inserting the thermistor into the positioning groove.

Preferably, the method includes a Step 1A after the Step 1 and before the Step 2, the Step 1A includes: winding a plurality of stator windings on the plurality of winding portions.

Preferably, the method includes a Step 2pre before the Step 2, the Step 2pre includes: providing a circuit board with the thermistor fixed thereon.

Preferably, two pins are formed on a top of the thermistor to fix the thermistor to the circuit board.

Preferably, the method further includes a Step 3 after the Step 2, the Step 3 includes: winding a plurality of stator windings on the plurality of winding portions, wherein a radial inner end of each winding portions is provided with a wire stopper, the stator windings are sandwiched between the corresponding wire stoppers and the sidewalls of the corresponding stop plates, and the thermistor is clamped between the positioning groove and the stator winding on the one of the winding portions.

Preferably, the positioning groove comprises a bottom wall and two side walls extending in an axial direction of the bobbin, and defines a first opening in the axial direction of the bobbin, the thermistor is inserted into the positioning groove from the first opening.

Preferably, the two side walls are configured as two inclined surfaces or arc surfaces that expand and extend outward from the bottom wall.

Preferably, two opposite recesses are defined in the two side walls for holding the thermistor in the positioning groove.

The bobbin provided by the embodiment of the present application only adopts a mechanical assembly method to fix the thermistor, and the assembly is convenient, which effectively improves the detection accuracy of the thermistor.

### BRIEF DESCRIPTION OF THE DRAWINGS

FIG. 1 shows a perspective view of a stator according to an embodiment of the present application.

FIG. 2 shows an exploded view of the stator of FIG. 1, wherein one stator winding is omitted, and the stator adopts a bobbin of a first embodiment of the present application.

FIG. 3 shows a perspective view of the bobbin of the stator of FIG. 2.

FIG. 4 shows an axial cross-sectional view of the stator of FIG. 2.

FIG. 5 shows an exploded view of the stator of FIG. 1, wherein the stator adopts a bobbin of a second embodiment of the present application.

FIG. 6 shows an axial cross-sectional view of the stator of FIG. 5.

### DETAILED DESCRIPTION OF THE PREFERRED EMBODIMENTS

Below, embodiments of the present invention will be described in greater detail with reference to the drawings. Elements of similar structures or functions are generally represented by like reference numerals for illustrative purposes throughout the figures. It should be noted that the figures are illustrative rather than limiting. The figures are not drawn to scale, do not illustrate every aspect of the described embodiments, and do not limit the scope of the present disclosure. Unless otherwise specified, all technical and scientific terms used in this disclosure have the ordinary meaning as commonly understood by people skilled in the art.

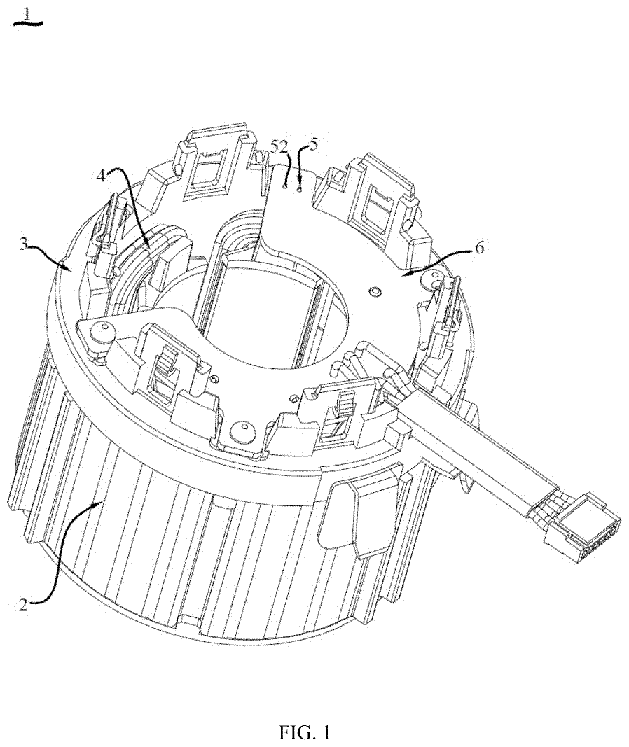

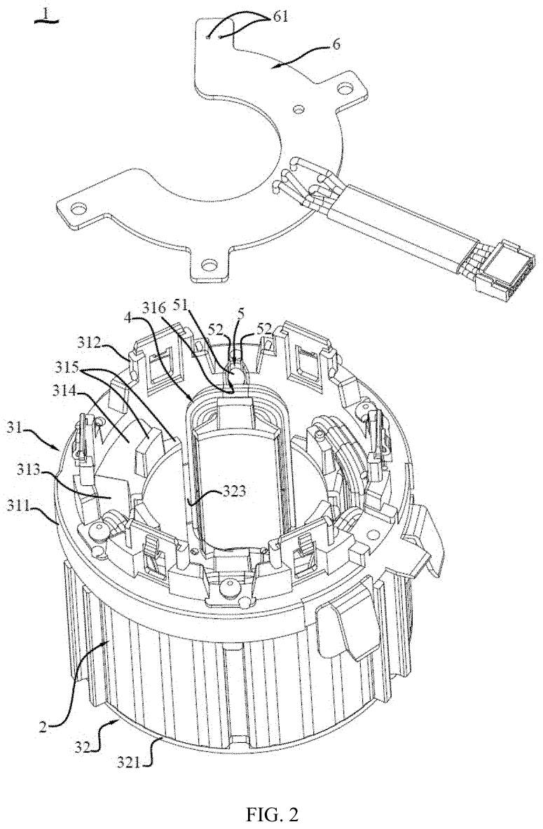

Referring to FIGS. 1 and 2, a stator 1 according to a first embodiment of the present application is shown. The stator 1 is an outer stator and can be used in an inner rotor motor. The stator 1 includes a stator core 2, a bobbin 3 fixed on the stator core 2, a plurality of stator windings 4 wound on the bobbin 3, and a thermistor 5 positioned between the bobbin 3 and one of the stator windings 4 for detecting a temperature of the stator windings 4. In this embodiment, the thermistor 5 is an NTC thermistor. Optionally, the thermistor 5 may be an other type of thermistor, such as a PTC thermistor, a CTR thermistor, etc. The specific structures of the stator core 2 and the stator windings 4 can adopt existing structures, which will not be described in detail here.

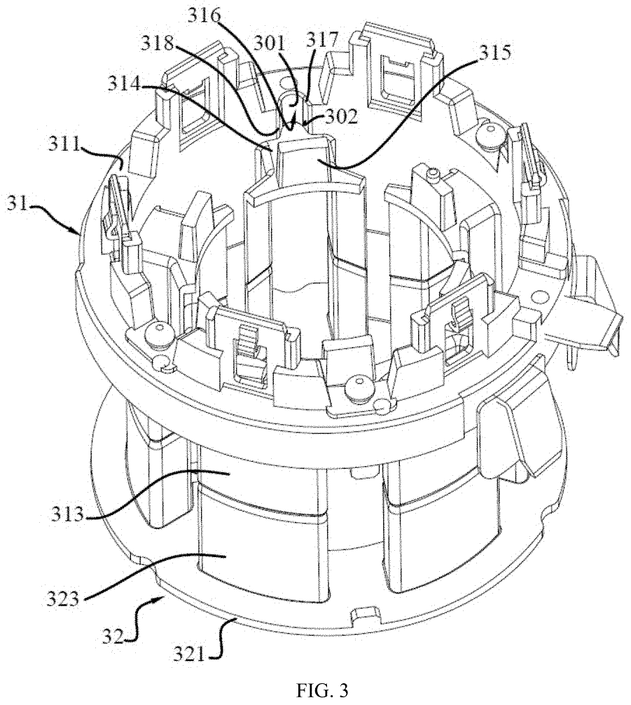

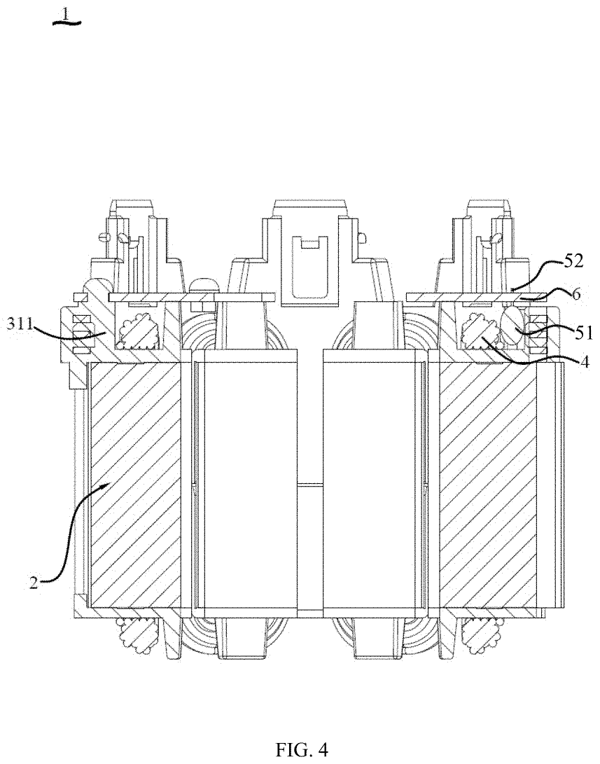

Referring to FIGS. 2 to 4, the bobbin 3 includes a first frame 31 and a second frame 32 arranged up and down. The first frame 31 and the second frame 32 are fixed on the stator core 2 from opposite axial ends of the stator core 2. The first frame 31 includes a ring shaped first stop plate 311, a plurality of wire passing portions 312 extending vertically upward from the first stop plate 311, and a plurality of first winding portions 313 extending vertically downward from a radial inner sidewall of the first stop plate 311. Each wire passing portion 312 is located between two adjacent first winding portions 313 in the circumferential direction of the bobbin 3. The second frame 32 includes a second stop plate 321 arranged opposite to the first stop plate 311. The first stop plate 311 and the second stop plate 321 abut against the two axial ends of the stator core 2 respectively. In addition, the second frame 32 further includes a plurality of second winding portions 323 that is symmetrically arranged with the first winding portions 313 and extends vertically upward from a radial inner sidewall of the second stop plate 321.

The plurality of first winding portions 313 of the first frame 31 are arranged at equal intervals along the circumferential direction of the first stop plate 311. A winding groove 314 is defined between the first stop plate 311 and a radial inner end of each first winding portion 313. Each second winding portion 323 is also correspondingly provided with a winding groove. Magnet wires are wound around the corresponding winding grooves of the first and second winding portions 313 and 323 of the first frame 31 and the second frame 32 to form the stator windings 4. A top and both sides of each first winding portion 313 and each second winding portion 323 are provided with wire stoppers 315 at a radial inner end of the corresponding winding groove to prevent the stator winding 4 from falling off. The stator winding 4 abuts between the first stop plate 311 and the wire stoppers 315. The shape of the wire stoppers 315 are not particularly limited.

A positioning groove 316 for accommodating the thermistor 5 is defined in the radial inner sidewall of the first stop plate 311. The positioning groove 316 is disposed above one of the first winding portions 313, that is, the positioning groove 316 is disposed between two wire passing portions 312. The positioning groove 316 extends along the axial direction of the stator 1 and opens toward the corresponding wire stopper 315. The positioning groove 316 includes a bottom wall 301 and two side walls 302 extending from opposite sides of the bottom wall 301. An upward first opening 317 in the axial direction of the stator 1 and an inward second opening 318 in the radial direction of the stator 1 are formed between the two side walls 302. Specifically, the positioning groove 316 penetrates the first stop plate 311 in the axial direction of the stator 1, that is, the positioning groove 316 extends upward from the winding groove 314 in the axial direction of the stator 1 to the first stop plate 311; the second opening 318 faces the corresponding winding groove 314, the corresponding wire stopper 315 on the first winding portion 313, and a central axis of the stator 1. Preferably, the positioning groove 316 is located at a middle position of the two wire passing portions 312, and is located on the symmetrical center line of the corresponding first winding portion 313. In this embodiment, the bottom wall 301 of the positioning groove 316 is substantially C-shaped, and the two side walls 302 are configured as two inclined surfaces or arc surfaces that expand and extend outward from the bottom wall 301.

In this embodiment, the thermistor 5 is fixed and electrically connected to a circuit board 6. The circuit board 6 is installed at an axial end of the first stop plate 311. The thermistor 5 is inserted into the positioning groove 316 from the first opening 317 to detect the temperature of the corresponding stator winding 4 on the first winding portion 313. The thermistor 5 includes a detecting body 51 and two rigid leads 52 extending from the detecting body 51. The detecting body 51 detects the temperature of the corresponding stator winding 4 and generates a detection signal, and the leads 52 transmit the detection signal to the circuit board 6.

The detecting body 51 is received in the positioning groove 316 and adjacent to the corresponding stator winding 4 through the second opening 318 of the positioning groove 316. Since the stator winding 4 is sandwiched between the first stop plate 311 and the wire stoppers 315, the detecting body 51 received inside the positioning groove 316 of the first stop plate 311 is adjacent to a radial outer end of the corresponding stator winding 4. Therefore, the above thermistor positioning method makes the thermistor 5 not need to be fixed on the stator winding by gluing, and also makes the thermistor 5 close to the stator winding to be detected, which improves the temperature detection accuracy of the thermistor 5 and the stability and reliability of the thermistor 5.

In this embodiment, the thermistor 5 is a leaded NTC thermistor. An outer surface of the detecting body 51 of the thermistor 5 is an arc shape, so that a side of the detecting body 51 facing the stator winding 4 can protrude from the second opening 318 of the positioning groove 316 to be closer to the corresponding stator winding 4, thereby improving the temperature detection accuracy of the thermistor 5. A bottom of the detecting body 51 of the thermistor 5 is arc-shaped, which can facilitate the thermistor 5 to be inserted into the positioning groove 316 from the first opening 317 from top to bottom. The leads 52 are large pins to fix the thermistor 5 on the circuit board 6. The circuit board 6 is provided with two fixing holes 61 at positions corresponding to the thermistor 6, and the leads 52 are fixed in the fixing holes 61.

In addition, edges bounding the first opening 317 of the positioning groove 316 is chamfered, and edges bounding the second opening 318 is rounded, thereby facilitating the installation of the thermistor 5 and not damaging the thermistor 5 due to sharp edges.

The present application also provides a thermistor positioning method for fixing the thermistor 5 on the bobbin 3 of the first embodiment of the present application. The method includes the following steps: providing the bobbin 3 of the first embodiment of the present application, wherein the bobbin has the positioning groove 316 for positioning the thermistor 5; the stator windings 4 are wound on the winding grooves of the first winding portions 313 and the corresponding second winding portions 323; the circuit board 6 with the thermistor 5 is fixed on the bobbin 3, wherein the thermistor 5 is inserted into the positioning groove 316 of the bobbin 3 from the first opening 317. Preferably, the method further includes providing the circuit board on which the thermistor 5 is mounted.

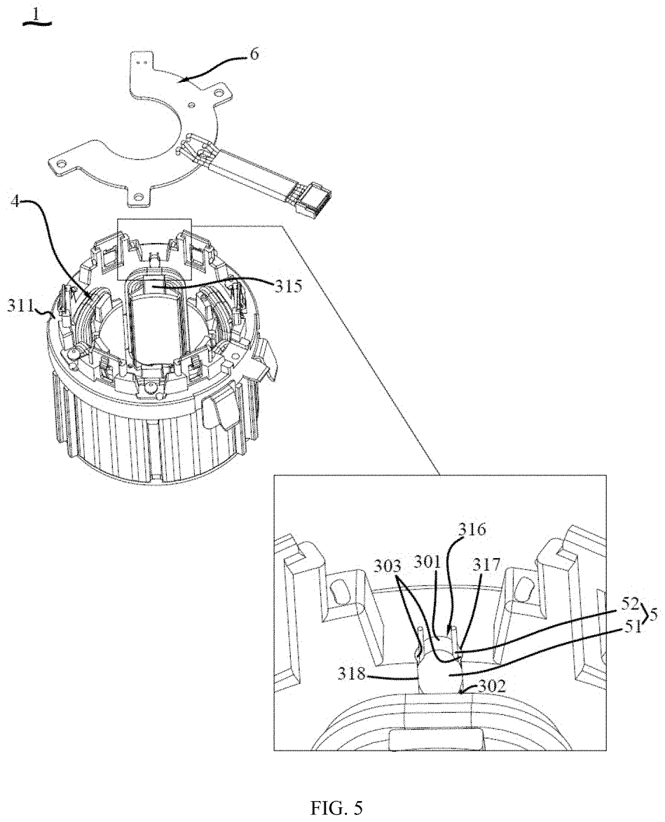

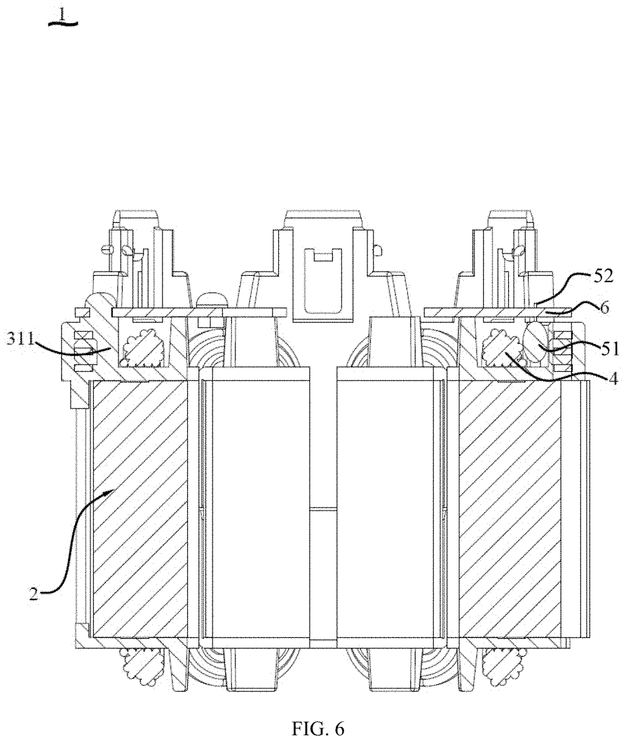

Referring to FIGS. 1, 5 and 6, a stator 1 according to a second embodiment of the present invention is shown. It should be noted that, the detailed description of the same structure of the second embodiment as that of the first embodiment is omitted here.

The difference between the second embodiment and the first embodiment is that the positioning groove 316 of the second embodiment is substantially C-shaped, and the two side walls 302 of the positioning groove 316 are recessed on both sides of the second opening 318 to form two recesses 303 opposite to each other. The two recesses 303 hold the thermistor 5 in the positioning groove 316. In this embodiment, the thermistor 5 is accommodated in the above-mentioned positioning groove 316, and abuts against the stator winding 4 wound on the corresponding winding groove 314, so that the temperature of the corresponding stator winding 4 can be detected. The thermistor 5 includes a detecting body 51 and two leads 52 extending from the detecting body 51. The detecting body 51 is received in the positioning groove 316 and protrudes from the second opening 318 of the positioning groove 316 to a radial inner side of the first stop plate 311. Since the stator winding 4 is sandwiched between the first stop plate 311 and the wire stoppers 315, the detecting body 51 can abut the corresponding stator winding 4. In other words, the detecting body 51 of this embodiment is clamped between the corresponding stator winding 4 and the positioning groove 316, that is, the detecting body 51 is pressed against the positioning groove 316 by the corresponding stator winding 4. Therefore, the above thermistor positioning method makes the thermistor 5 not need to be fixed on the stator winding by gluing, and at the same time ensures the temperature detection accuracy of the thermistor 5 and the stability and reliability of the thermistor 5.

In the second embodiment, an outer surface of the detecting body 51 of the thermistor 5 is an arc shape, so that the detecting body 51 protrudes from the radial inner sidewall of the first stop plate 311 through the second opening 318 of the positioning groove 316, and abuts the corresponding stator winding 4 in a close contact manner, thereby improving the temperature detection accuracy of the thermistor 5. Optionally, only one side of the detecting body 51 facing the corresponding stator winding 4 may be set in an arc shape. The circuit board 6 may be installed at the axial end of the first stop plate 311. Optionally, the circuit board of the second embodiment can also be arranged at other positions, the thermistor 5 may be electrically conncected to the circuit board by wires.

The present application further provides a thermistor positioning method for fixing the thermistor 5 on the bobbin 3 of the second embodiment of the present application. The method includes the following steps: providing the bobbin 3 of the second embodiment of the present application, wherein the bobbin has the positioning groove 316 for positioning the thermistor 5; placing the thermistor 5 in the positioning groove 316 of the bobbin 3; and winding the stator windings 4 on the winding grooves of the first winding portions 313 and the corresponding second winding portions 323 of the bobbin 3, wherein opposite radial ends of one of the stator windings 4 are respectively against the thermistor 5 and the corresponding wire stoppers 315.

In the above two embodiments, the first winding portions 313 and the corresponding second winding portions 323 together constitute the winding portions of the bobbin. In other embodiments, the winding portions can also be other existing structures.

Therefore, the technical solutions of embodiments of the present invention have been clearly and completely described above. Apparently, the described embodiments are merely part of, rather than all of, the embodiments of the present invention. A person skilled in the art may make various combinations of technical features in the various embodiments to meet practical needs. Based on the described embodiments of the present invention, any other embodiment obtained by a person skilled in the art without paying creative efforts shall also fall within the scope of the present invention.

1. A bobbin for a stator, comprising:
a ring shaped stop plate; and
a plurality of winding portions extending downward from a sidewall of the stop plate, wherein a positioning groove is defined in the sidewall of the stop plate toward one of the winding portions for accommodating a thermistor, the positioning groove opens toward the one of the winding portions.

2. The bobbin of claim 1, wherein a radial inner end of each winding portion is provided with a wire stopper extending upward, the positioning groove is arranged above the one of the winding portions and is opposite to the wire stopper on the one of the winding portions in a radial direction of the bobbin.

3. The bobbin of claim 2, wherein the positioning groove comprises a bottom wall and two side walls extending in an axial direction of the bobbin, and defines an upward first opening in the axial direction of the bobbin and a second opening in a radial direction of the bobbin facing the corresponding wire stopper.

4. The bobbin of claim 3, wherein the two side walls are configured as two inclined surfaces or arc surfaces that expand and extend outward from the bottom wall.

5. The bobbin of claim 3, wherein two opposite recesses are defined in the two side walls for holding the thermistor in the positioning groove.

6. A stator, comprising:
a stator core;
a bobbin mounted on the stator core, the bobbin comprising two stop plates respectively fixed to two axial ends of the stator core, and a plurality of winding portions extending from a sidewall of each stop plate toward the opposite stop plate;
a plurality of stator windings wound around the plurality of winding portions; and
a thermistor;
wherein a positioning groove is defined in the sidewall of one of the stop plates toward one of the winding portions on the one of the stop plates for accommodating the thermistor, the positioning groove is adjacent to and opens toward the stator winding on the one of the winding portions.

7. The stator of claim 6, wherein the positioning groove comprises a bottom wall and two side walls extending in an axial direction of the bobbin, and defines a first opening in the axial direction of the bobbin, the thermistor is received in the positioning groove with a top of the thermistor protruding out of the first opening and electrically connected to a circuit board.

8. The stator of claim 7, wherein the circuit board is fixed on the one of the stop plates having the thermistor, the thermistor comprises two pins on the top, the pins protrude out of the first opening and fix the thermistor to the circuit board.

9. The stator of claim 7, wherein the positioning groove defines a second opening between the two side walls toward the stator winding on the one of the winding portions, a side of the thermistor is an arc shape and exposed from the second opening to be adjacent to or abut against the stator winding on the one of the winding portions.

10. The stator of claim 9, wherein the two side walls are configured as two inclined surfaces or arc surfaces that expand and extend outward from the bottom wall.

11. The stator of claim 9, wherein two opposite recesses are defined in the two side walls for holding the thermistor in the positioning groove.

12. A positioning method for a thermistor, comprising:
Step 1: providing a stator having a stator core and a bobbin mounted on the stator core, wherein the bobbin comprises two stop plates respectively fixed to two axial ends of the stator core, and a plurality of winding portions extending from a sidewall of each stop plate toward the opposite stop plate, a positioning groove is defined in the sidewall of one of the stop plates toward one of the winding portions on the one of the stop plates, the positioning groove opens toward the one of the winding portions; and
Step 2: inserting the thermistor into the positioning groove.

13. The positioning method of claim 12, comprising a Step 1A after the Step 1 and before the Step 2, the Step 1A comprising:
winding a plurality of stator windings on the plurality of winding portions.

14. The positioning method of claim 12, comprising a Step 2pre before the Step 2, the Step 2pre comprising:
providing a circuit board with the thermistor fixed thereon.

15. The positioning method of claim 14, wherein two pins are formed on a top of the thermistor to fix the thermistor to the circuit board.

16. The positioning method of claim 12, further comprising a Step 3 after the Step 2, the Step 3 comprising:
winding a plurality of stator windings on the plurality of winding portions, wherein a radial inner end of each winding portions is provided with a wire stopper, the stator windings are sandwiched between the corresponding wire stoppers and the sidewalls of the corresponding stop plates, and the thermistor is clamped between the positioning groove and the stator winding on the one of the winding portions.

17. The positioning method of claim 12, wherein the positioning groove comprises a bottom wall and two side walls extending in an axial direction of the bobbin, and defines a first opening in the axial direction of the bobbin, the thermistor is inserted into the positioning groove from the first opening.

18. The positioning method of claim 17, wherein the two side walls are configured as two inclined surfaces or arc surfaces that expand and extend outward from the bottom wall.

19. The positioning method of claim 17, wherein two opposite recesses are defined in the two side walls for holding the thermistor in the positioning groove.
